(19) United States
(12) Patent Application Publication
(10) Pub. No.: US 2026/0158806 A1
(43) Pub. Date: Jun. 11, 2026

(54) REGISTRY BOOK ASSEMBLY

(71) Applicants: Reese Price, Chicago, IL (US); Issac Gene Crawford, Chicago, IL (US)

(72) Inventors: Reese Price, Chicago, IL (US); Issac Gene Crawford, Chicago, IL (US)

(21) Appl. No.: 18/976,015

(22) Filed: Dec. 10, 2024

(51) Int. Cl. B41L 1/24

(52) U.S. Cl. CPC B41L 1/24

(57) ABSTRACT

A registry book assembly includes at least one sheet subassembly. Each sheet subassembly comprises a first sheet and a second sheet. The first sheet is arranged atop the second sheet. The first sheet comprises a plurality of registration areas. Each sheet subassembly comprises a transfer mechanism that transfers information written on the first sheet onto the second sheet underlying the first sheet. The second sheet comprises a plurality of detachable labels that correspond to the plurality of registration areas of the first sheet.

### FIELD OF THE INVENTION

The present invention relates generally to registry books. More specifically, the present invention is a new registry book that provides a record of visitors attending an event and detachable mailing labels. However, the present invention is not limited to this option, and it may further be adapted for different purposes.

### BACKGROUND OF THE INVENTION

A registry book is a paper means for a visitor to acknowledge a visit to a site, physical or web-based, and leave details such as their name, address, etc. Such paper-based ledgers or books are traditionally used in churches, at weddings, funerals, museums, schools, institutions and other private facilities open to the public. Some private homes also keep visitors'books. Specialized forms of registry books include hotel registers, wherein guests are required to provide their contact information, and Books of Condolence, which are used at funeral homes and more generally after notable public deaths, such as the death of a monarch or president, or after a public disaster, such as an airplane crash.

### SUMMARY OF THE INVENTION

The present invention discloses a registry book assembly comprising at least one sheet subassembly. Each sheet subassembly comprises a first sheet and a second sheet. The first sheet is arranged atop the second sheet. The first sheet comprises a plurality of registration areas. Each sheet subassembly comprises a transfer mechanism that transfers information written on the first sheet onto the second sheet underlying the first sheet. The second sheet comprises a plurality of detachable labels that correspond to the plurality of registration areas of the first sheet.

In one embodiment, the transfer mechanism comprises a coated back first sheet and a coated front second sheet.

In one embodiment, the plurality of detachable labels comprises self-adhesive labels.

In one embodiment, each sheet subassembly further comprises a third sheet that is positioned underlying the second sheet and configured to prevent the information written on the first sheet from transferring to an underlying sheet subassembly.

In one embodiment, the third sheet comprises a tab member.

### BRIEF DESCRIPTION OF THE DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the present invention. That is, the dimensions of the components of the present invention, independently and in relation to each other can be different. It should be noted that the drawings are schematic and not necessarily drawn to scale. Some drawings are enlarged or reduced to improve drawing legibility.

FIG. 1 depicts a perspective view of the present invention.

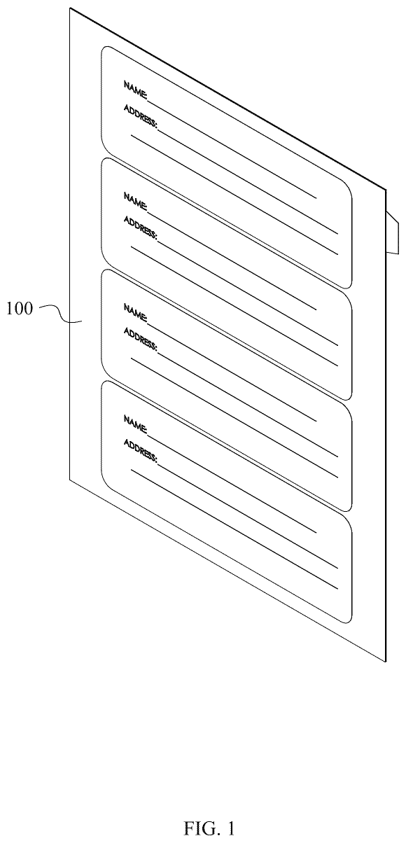

FIG. 2 depicts a front perspective exploded view of the present invention.

FIG. 3 depicts a rear perspective exploded view of the present invention.

FIG. 4 depicts a front view of the second sheet of the present invention.

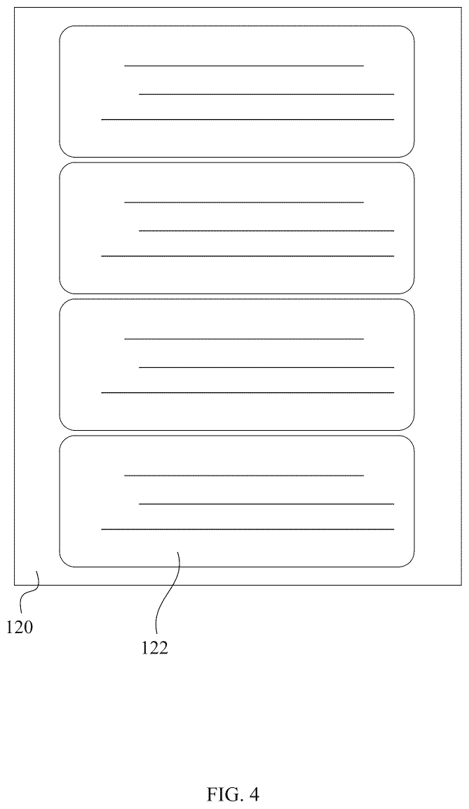

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and is made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. When not explicitly defined herein, to the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “proximate” refers to positions that are situated close/near in relationship to a structure. As used in the following description, the term “distal” refers to positions that are situated away from positions.

The present disclosure includes many aspects and features. Moreover, while many aspects and features relate to, and are described in the context of registry book assemblies, embodiments of the present disclosure are not limited to use only in this context.

The present invention is a registry book assembly. It is an aim of the present invention to provide a registry book assembly that is capable of transferring written information onto a mailing label.

Referring now to the figures of the present disclosure. The registry book assembly of the present invention comprises at least one sheet subassembly 100.

The at least one sheet subassembly 100 may be coupled together to form a book. Each sheet subassembly 100 comprises a first sheet 110 and a second sheet 120. The first sheet 110 is arranged atop the second sheet 120. The first sheet 110 is configured to provide a writing surface that can be written on by a writing instrument, such as a fountain pen, a ballpoint pen, a rollerball pen, and a pencil, etc. The first sheet comprises a plurality of registration areas 112. Each registration area 112 is preferably printed with designated spaces for the guest's name and address. Each sheet subassembly 100 further comprises a transfer mechanism 114 that transfers information written on the first sheet 110 onto the second sheet 120 underlying the first sheet 110. Moreover, the second sheet 120 comprises a plurality of detachable labels 122 that correspond to the plurality of registration areas 112 of the first sheet 110. In this way, when the guest's name and address are written on the first sheet, the written information will be transferred onto the detachable labels. Each label comprises the mailing information of one guest. The label may then be detached from the second sheet and attached to an envelope. In a preferred embodiment, the plurality of detachable labels comprises self-adhesive labels such that the detached label can be easily attached to the envelope.

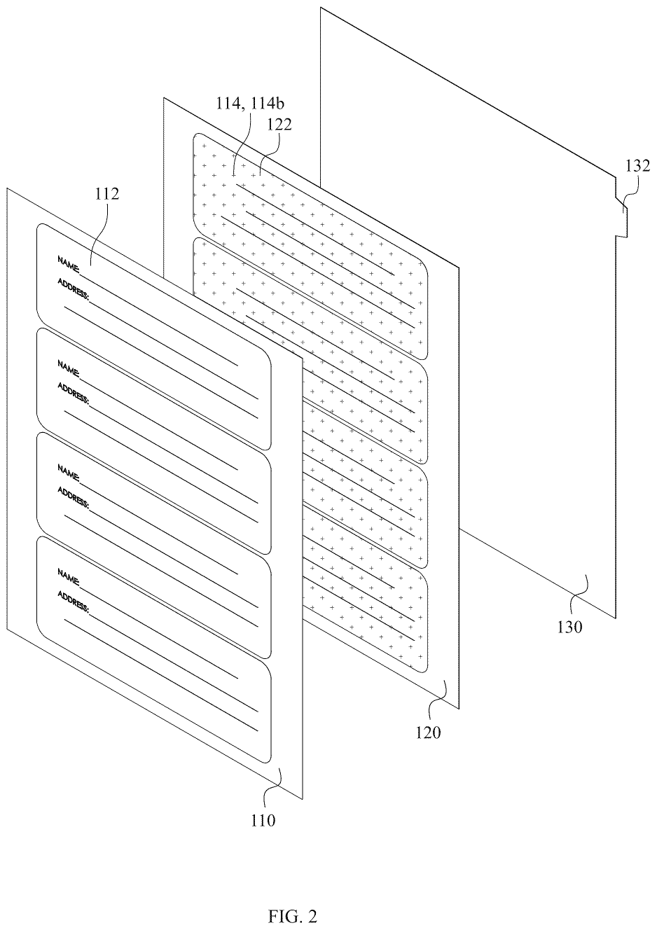

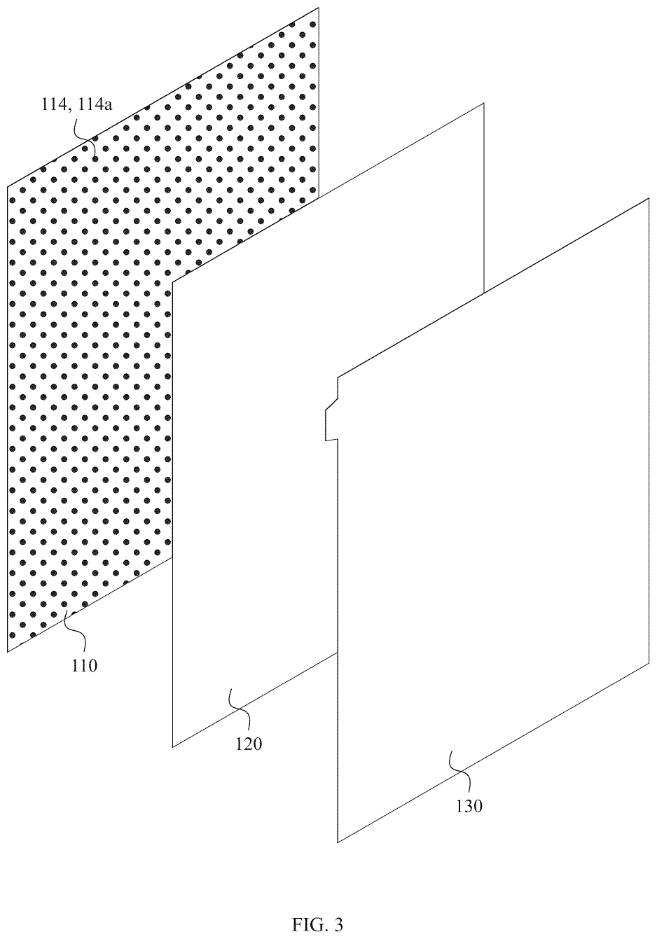

Any suitable transfer mechanism may be used, such as but not limited to carbonless coatings, carbon paper, etc. However, carbonless coatings are preferred. In one embodiment, the transfer mechanism 114 comprises a coated back carbonless first sheet 114a and a coated front carbonless second sheet 114b, as shown in FIGS. 2 and 3. In another embodiment, the transfer mechanism comprises a self-contained carbonless coating on the second sheet 120, in particular on the plurality of detachable labels 122.

In one embodiment, each sheet subassembly 100 further comprises a third sheet 130 that is positioned underlying the second sheet and configured to prevent the information written on the first sheet 110 from transferring to an underlying sheet subassembly. In a preferred embodiment, the third sheet 130 comprises a tab member 132. The tab member 132 preferably extends laterally outward from the third sheet 130 to allow the next sheet subassembly to be easily accessible by lifting the tab member 132.

It is envisioned that the sizes of the sheets forming the present invention can vary based on design requirements.

Although the disclosure has been explained in relation to its preferred embodiment, it is to be understood that many other possible modifications and variations can be made without departing from the spirit and scope of the disclosure.

1. A registry book assembly comprising:
a plurality of sheet subassemblies, wherein each sheet subassembly comprising:
(i) a first sheet having a plurality of registration areas configured to receive handwritten information;
(ii) a second sheet positioned underlying the first sheet, the second sheet having a plurality of detachable labels corresponding to the plurality of registration areas of the first sheet; and
(iii) a third sheet positioned underlying the second sheet and configured to prevent information written on the first sheet from transferring to an underlying sheet subassembly;
(iv) wherein the third sheet further comprises a tab member extending laterally outward from the third sheet to facilitate access to a next sheet subassembly.

2. The registry book assembly as claimed in claim 1, wherein the transfer mechanism comprises a coated back first sheet and a coated front second sheet.

3. The registry book assembly as claimed in claim 1, wherein the plurality of detachable labels comprises self-adhesive labels.

4. The registry book assembly as claimed in claim 1, wherein each sheet subassembly further comprises a third sheet that is positioned underlying the second sheet and configured to prevent the information written on the first sheet from transferring to an underlying sheet subassembly.

5. The registry book assembly as claimed in claim 4, wherein the third sheet comprises a tab member.
